(19) United States
(12) Patent Application Publication
(10) Pub. No.: US 2008/0071922 A1
(43) Pub. Date: Mar. 20, 2008

(54) METHODS, SYSTEMS, AND COMPUTER PROGRAM PRODUCTS TO TRANSPARENTLY DISPATCH REQUESTS TO REMOTE RESOURCES IN A MULTIPLE APPLICATION SERVER ENVIRONMENT

(75) Inventors: Madhu K. Chetuparambil, Raleigh, NC (US); Srinivas Hasti, Raleigh, NC (US); Stephan Hesmer, Gaertringen (DE); Curtiss J. Howard, Raleigh, NC (US); Todd E. Kaplinger, Raleigh, NC (US); Timo Kussmaul, Boeblingen (DE); Maxim A. Moldenhauer, Durham, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/533,113

(22) Filed: Sep. 19, 2006

(51) Int. Cl. G06F 15/173; G06F 15/16

(52) U.S. Cl. 709/236; 709/226

(57) ABSTRACT

A method, system, and computer program product to transparently dispatch requests to a remote resource using a remote request dispatcher (RRD) in a managed multiple application server environment. The method includes executing a local resource on a local Web module on a local application server. The local resource contains a reference to a remote resource on a remote Web module on a remote application server. The method also includes building an RRD request object on the local application server, and sending the RRD request object to the remote application server. Upon receipt, the method further includes generating a request on the remote application server to an internal controller servlet to perform an include operation on the remote resource, intercepting the request to the internal controller servlet on the remote application server, wrapping the request to the servlet with information received in the RRD request object, and building an RRD response object on the remote application.

### CROSS-REFERENCE TO RELATED APPLICATIONS

This application contains subject matter related to the subject matter of the following co-pending application, which is assigned to the same assignee as this application, International Business Machines Corporation of Armonk, N.Y. The below listed application is hereby incorporated herein by reference in its entirety:

U.S. Patent Application Attorney Docket No. RSW920060097US1, entitled METHODS, SYSTEMS, AND COMPUTER PROGRAM PRODUCTS FOR EXTENDING REMOTE REQUEST DISPATCHER FRAMEWORK FOR CONTAINER BASED PROGRAMMING MODELS, filed on Sep. 19, 2006.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to distributed computing systems, and particularly to methods, systems, and computer program products to transparently dispatch requests to remote resources in a multiple application server environment.

2. Description of Background

Before our invention, Java servlet technology supported request dispatching either within a currently executing Web application for relative resources or within the scope of a running application server when a specific Web application's servlet context was referenced. Servlets provide a component-based, platform-independent method for building Web-based applications through server-side modules that fit into a Web server framework. JavaServer page (JSP) technology is an extension of servlet technology supporting the combination of fixed or static template data with dynamic content for a client such as a Web browser. JSPs allow separation of front-end presentation from business logic in middle and back-end tiers of distributed systems. When a JSP resource is called, it is compiled by a JSP engine into a Java servlet. A Web application is an application comprised of one or more related Web resources that are managed as a group, such as Hypertext Markup Language (HTML) pages, JSP files, servlets, or custom tag libraries. Web resources are also referred to as Web components or Web application components. A Web module is a deployable Web application unit that consists of one or more Web components, other resources, and a Web application deployment descriptor contained in a hierarchy of directories and files in a standard Web application format. A Web module is installed and run in a Web container on an application server. Application servers extend a Web server's capabilities to handle Web application requests, typically using Java technology.

A servlet context is an object that contains a servlet's view of the Web application within which the servlet is running. Using a servlet context, a servlet can log events, obtain references to resources, and set and store attributes that other servlets in the context can use. A Java servlet request dispatcher is an object that allows a resource to forward processing of a request to another resource or to include the output of another resource as part of the response to the requesting client. An example of a Java servlet request dispatcher interface, which can implement a Java servlet request dispatcher object, is the javax.servlet.RequestDispatcher interface provided in the J2EE Servlet 2.4 Specification.

Two known methods of including resources outside of the context of an application server are through the use of JavaServer Tag Libraries (JSTL) and Edge Side Includes (ESI). JSTL provides a method to include resources located outside of the context of an application server through using a custom tag named “import”. The tag has a required parameter named “url” that accepts a fully qualified Uniform Resource Locator (URL). The custom tag creates a new request to the URL referenced, makes the required connection, and returns the output from the URL specified to the calling resource. ESI allows content assembly by Hypertext Transfer Protocol (HTTP) surrogates, by providing an in-markup Extensible Markup Language (XML)-based language. ESI defines fragments of Web pages, allowing them to be assembled and updated at the edge of a network such as the Internet, which is closer to the end-user client, rather than assembling Web pages at the origin servers.

While methods exist to include resources outside of the context of an application server, they do not allow the remote resource to access the requestor's related state, also known as the request context. Examples of the requestor's related state are POST data from the original request, original request headers, security credentials, HttpServletRequest attributes, HttpSession identifiers, locale, character encoding, and request URL path elements. It is also desirable to allow installation of applications on separate application servers without requiring modification of application code. Accordingly, because existing technologies are limited in their scope of application or do not support passing request context, a method of transparently calling a remote resource while passing request context in a multiple application server environment is needed.

### SUMMARY OF THE INVENTION

The shortcomings of the prior art are overcome and additional advantages are provided through the provision of methods, systems, and computer program products to transparently dispatch requests to a remote resource using a remote request dispatcher (RRD) in a managed multiple application server environment including a local application server and a remote application server. The method includes executing a local resource on a local Web module on the local application server, said local resource containing a reference to a remote resource on a remote Web module on the remote application server. The method also includes locating the remote Web module associated with the referenced remote resource, building an RRD request object on the local application server, and sending the RRD request object from the local application server to the remote application server. The method further includes receiving the RRD request object on the remote application server, including an internal controller servlet in the remote application server, generating a request on the remote application server to the internal controller servlet to perform an include operation on the remote resource, intercepting the request to the internal controller servlet on the remote application server, wrapping the request to the internal controller servlet with information received in the RRD request object on the remote application server, and building an RRD response object on the remote application. The RRD response object includes remote resource contents, remote resource response output, and remote resource response state. The method additionally includes sending the RRD response object from the remote application server to the local application server, receiving the RRD response object on the local application server, and making contents of the RRD response object available to the local resource.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

As a result of the summarized invention, technically we have achieved a solution, which transparently dispatches requests to remote resources in a multiple application server environment through a remote request dispatcher (RRD). An RRD enables a remote resource to access the requestor's related state information and allows installation of applications on separate application servers without requiring modification of application code.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram of a system upon which a remote request dispatcher may be transparently implemented in exemplary embodiments;

FIG. 2 illustrates one example of a JavaServer Page using JavaServer Page Standard Tag Library to transparently import a Web module within the scope of a multiple application server environment;

FIG. 3 illustrates one example of a JavaServer Page using JavaServer Page Standard Tag Library capable of being transparently imported as a Web module within the scope of a multiple application server environment;

FIG. 4A illustrates one example of a flow diagram describing a process for implementing a remote request dispatcher request to a remote resource and a response to a client system in exemplary embodiments; and

FIG. 4B illustrates one example of a flow diagram describing a process for responding to a remote request dispatcher request as a continuation of the process illustrated in FIG. 4A in exemplary embodiments.

The detailed description explains the preferred embodiments of the invention, together with advantages and features, by way of example with reference to the drawings.

### DETAILED DESCRIPTION OF THE INVENTION

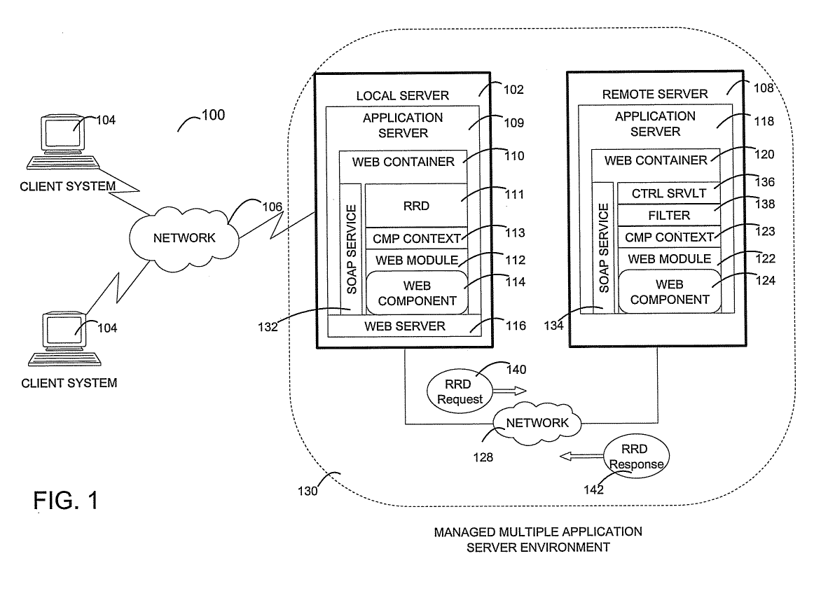

Turning now to the drawings in greater detail, it will be seen that in FIG. 1 there is a block diagram of a system upon which requests targeted to remote resources can be transparently dispatched in a multiple application server environment.

The system 100 of FIG. 1 includes a local server 102 in communication with client systems 104 over a network 106. The system 100 of FIG. 1 also depicts a remote server 108 in communication with local server 102 over a network 128; this combination is collectively referred to as a managed multiple application server environment 130. Local server 102 may be a high-speed processing device (e.g., a mainframe computer) that handles large volumes of processing requests from client systems 104. In exemplary embodiments, local server 102 functions as an application server, Web server, and database management server. Client systems 104 may comprise desktop or general-purpose computer devices that generate data and processing requests, such as requests to utilize applications and perform searches. For example, client systems 104 may request Web pages, documents, and files that are stored in various storage systems. In exemplary embodiments, remote server 108, like local server 102, also functions as an application server, Web server, and database management server. In exemplary embodiments, remote server 108 may not be in communication with client systems 104, while local server 102 may be in communication with client systems 104. Although only two servers 102 and 108 are shown in FIG. 1, it will be understood that multiple servers may be implemented as part of managed multiple application server environment 130, with each server in communication with one another via direct coupling or via one or more networks such as network 128. For example, multiple servers may be interconnected through a distributed network architecture, with each server running zero or more application servers and zero or more Web servers. Furthermore, local server 102 and remote server 108 may be independent software processes both executing on a shared hardware system.

Networks 106 and 128 may be any type of communications network known in the art. For example, networks 106 and 128 may be intranets, extranets, or internetworks, such as the Internet, or a combination thereof. Networks 106 and 128 may be wireless or wireline networks. Networks 106 and 128 may be components of a common network or may be isolated from each other. Network 128 may be a combination of internal hardware and software communication schemes when servers such as local server 102 and remote server 108 embodied in managed multiple application server environment 130 execute on a shared hardware system.

In exemplary embodiments, both local server 102 and remote server 108 run application servers, such as application servers 109 and 118. On local server 102, application server 109 holds Web container 110 to enable communication between Web module 112 and Web server 116. On remote server 108, application server 118 holds Web container 120. In exemplary embodiments, a Web server hosts one or more Web containers, providing services such as Hypertext Transfer Protocol (HTTP) message handling. Remote server 108 may also run a Web server to support load balancing in managed multiple application server environment 130. A Web container is part of an application server in which Web application components run. Web applications are comprised of one or more related Web resources, also called Web components or Web application components, which are managed as a unit such as servlets, JavaServer Pages technology (JSP files), and Hypertext Markup Language (HTML) files. One or more Web application components make up a Web application, which is also referred to as a Web module. In FIG. 1, local server 102 executes Web module 112, which runs Web component 114. In this example, Web component 114 may be a Java servlet. Also in FIG. 1, remote server 108 executes Web module 122, which runs Web component 124 such as a Java servlet.

A Web application running on application server 109 as Web module 112 may allow client systems 104 to each receive different personalized content through JSPs, which run as individual Java servlets such as Web component 114. The users of client systems 104 may each see different customized content, for example personal bank account information or investment portfolios. The information required to construct the customized content for the users of client systems 104 may reside on separate application servers such as application server 109 and application server 118. In exemplary embodiments, Web component 114 may attempt to incorporate the output of the Web component 124 as part of the response to client systems 104. In prior art systems, the ability to capture the output of the response of another Web component using a Request Dispatcher, as defined in J2EE Servlet 2.4 Specification, is limited to the case where either both Web components are located within the scope of the same Web application or within the scope of the running application server when a specific Web application's servlet context is referenced. Accordingly, a prior art system attempting to use a Request Dispatcher while running Web component 114 on application server 109 would fail in dispatching a request to Web component 124, because Web container 110 would be unable to locate Web component 124 on application server 118 in the present example. This limitation has been overcome through the inventive principles of a Remote Request Dispatcher (RRD).

An RRD extends the scope of a Java servlet Request Dispatcher from an application server to the scope of a managed multiple application server environment. A managed multiple application server environment is a collection of application servers typically used for distributed computing systems and depicted in exemplary embodiments as managed multiple application server environment 130, comprised of application server 109 communicably coupled through network 128 with application server 118. An RRD supports JavaServer Tag Libraries (JSTL) such as a JSTL custom tag to import or include contents in the scope of the same request from outside of the current Web module context by specifying a context parameter. JSTL is restricted in that a Web module that is imported must run inside of the same Java virtual machine (JVM) as the calling resource if the imported URL is not fully qualified. An RRD extends the JSTL functionality by permitting the imported Web module to be located within the scope of a managed multiple application server environment, and thus is not limited to the scope of the current (local) application server. An RRD is implemented as an object on the local application server, depicted as RRD object 111.

The scope of a resource, such as a servlet, is determined by examining its context. A servlet context is an object that contains a servlet's view of the Web application within which the servlet is running. An example servlet context is depicted as component context 113 of Web component 114 running within Web module 112. On remote server 108, another example servlet context is depicted as component context 123 of Web component 124 running within Web module 122.

Communication between application servers may be handled through the use of Web services communicating via Simple Object Access Protocol (SOAP). SOAP is a lightweight, Extensible Markup Language (XML)-based protocol for exchanging information in a decentralized, distributed environment. SOAP enables users to query and return information and invoke services across a network such as the Internet. In exemplary embodiments, local application server 109 communicates using SOAP Web services client 132 over network 128 with SOAP Web services servlet 134 on remote application server 118.

In exemplary embodiments, requests received by remote Web container 120 through SOAP Web services servlet 134, are managed within remote Web container 120 using a controller servlet 136. The contents of a request, such as RRD request object 140, or the contents of a response to a request, such as RRD response object 142, may be modified in remote Web container 120 through an intermediary object, such as filter 138. A filter transforms the content of requests, responses, and header information using wrappers. Filters do not generally create a response or respond to a request as servlets do; rather, through wrappers, filters modify or adapt a request for and a response from a resource. Thus a filter may be used to make a request to controller servlet 136 in remote Web container 120 appear as if it is from local Web component 114.

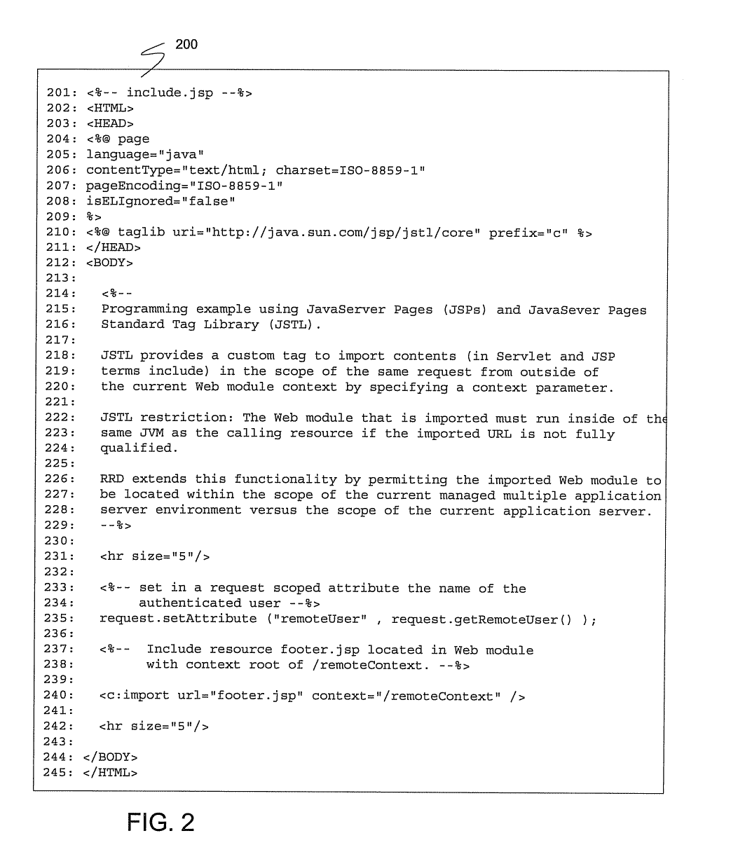

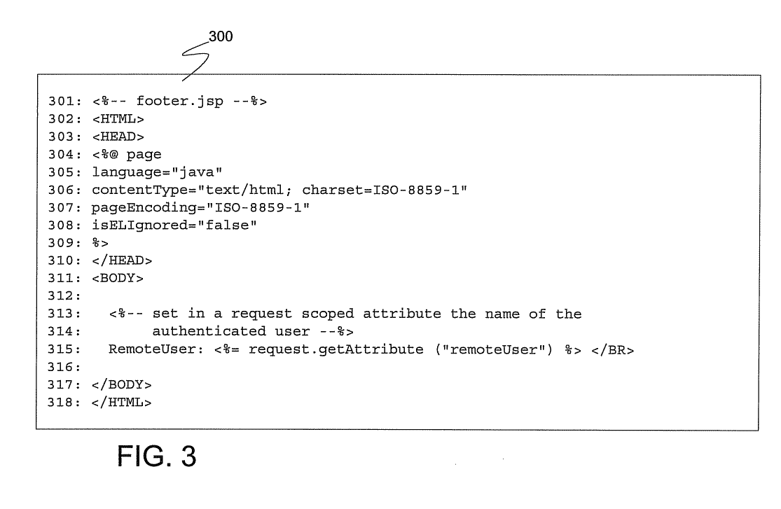

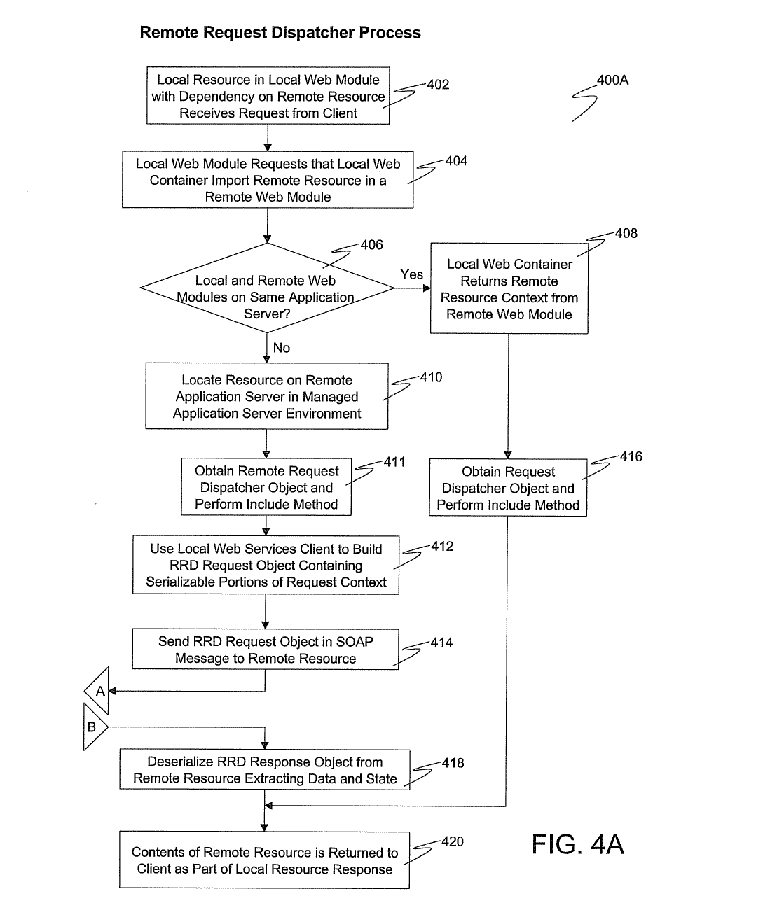

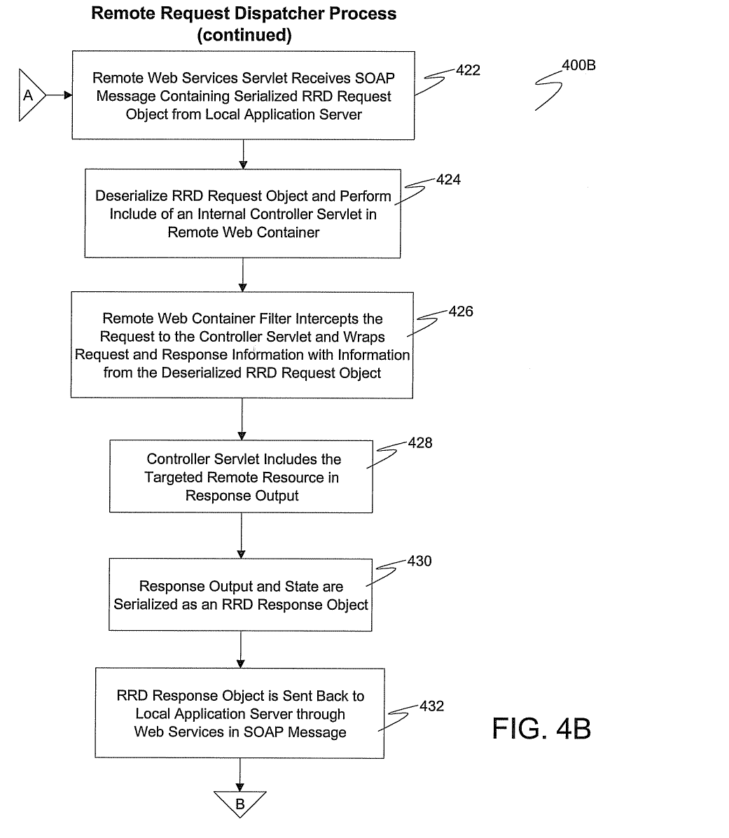

Turning now to FIG. 2 and FIG. 3, programming examples of resources include.jsp 200 and footer.jsp 300 for implementing a transparent remote request dispatcher will now be described in accordance with exemplary embodiments. A process to implement an RRD in accordance with exemplary embodiments is provided in process flows 400a in FIG. 4A and 400b in FIG. 4B. Process flow 400A depicts an RRD request to a remote resource that continues into process flow 400b, which depicts an RRD response, and the process flow then returns to 400a where the contents of the RRD response output is included in a response to a client system 104. At process step 402, a local resource include.jsp 200 receives a request from client system 104. Local resource include.jsp 200 is depicted as Web component 114 running on Web module 112 in Web container 110, associated with the context root of “/” (e.g. http://localhost/include.jsp) on application server 109. At process step 404, when executing local resource include.jsp 200, Web container 110 is requested to import remote resource footer.jsp 300 at line 240 of FIG. 2, which is depicted as Web component 124 running on Web module 122 associated with a context root of “/remoteContext”. Here the term “remote” resource indicates that, at a minimum, the resource is outside of the context root of the “local” resource. The remote resource may be located on a separate application server relative to the local resource, but further checking must be performed to make this determination. A context check may be performed to determine the location of the requested context “/remoteContext”. In exemplary embodiments, when an optional parameter context is passed to a JSTL import tag, Web container 110 first calls javax.servlet.ServletContext.getContext (java.lang.String uriPath) to obtain the Web module associated with the context root of “/remoteContext”. At process step 406, a check is performed to determine if Web module 112 running local resource include.jsp 200 and Web module 122 running footer.jsp 300 are both on local application server 109. In systems using prior art methods such as those defined by the J2EE Servlet 2.4 Specification, if Web container 110 is unable to locate a matching context in local application server 109, Web container 110 would return a null and remote resource footer.jsp 300 would not be imported. Using the inventive principles embodied in an RRD, Web container 110 first attempts to locate the servlet context of remote resource footer.jsp 300 using prior art methods such as those defined by the J2EE Servlet 2.4 Specification. There are two possible results of the context check:

Scenario 1. Both local resource include.jsp 200 and remote resource footer.jsp 300 are installed on local application server 109. If this is the case, at process step 408, Web container 110 returns the servlet context associated with the context root “/remoteContext”.

Scenario 2. Local resource include.jsp 200 and remote resource footer.jsp 300 are installed on two different application servers, such as local application server 109 and remote application server 118. At process step 410, using technologies known in the art, such as a combination of On Demand Config and Unified Cluster Framework technology, a Web Services Dynamic Workload Management client is able to locate the remote resource footer.jsp 300 in managed application server environment 130. This example is illustrated in FIG. 1, where remote resource footer.jsp 300 is shown as Web component 124 and the remote servlet context is shown as component context 123.

Continuing with the example, if the servlet context of remote resource footer.jsp 300 is found, a JSTL import tag may then call javax.servlet.ServletContext.getRequestDispatcher (“/footer.jsp”). This call obtains an appropriate version of a Request Dispatcher object, with a prior art Request Dispatcher object returned when the resources are within the scope of local application server 109 in process step 416, or an enhanced Request Dispatcher object, RRD object 111, that is capable of locating remote servlet context 123 in process step 411. A JSTL import tag call to the include method of the selected Request Dispatcher object, such as javax.servlet.RequestDispatcher.include(HttpServletRequest request, HttpServletResponse response), results in the inclusion of the contents of footer.jsp 300 as part of a response sent to a client system 104. In process step 416, the include method associated with a prior art Request Dispatcher object uses the prior art methods to obtain output data from remote resource footer.jsp 300. In process step 411, the include method of an enhanced Request Dispatcher object, RRD object 111, continues with additional process steps to obtain output data from remote resource footer.jsp 300, proceeding next to process step 412.

In process step 412, instead of using a prior art Request Dispatcher object, through RRD object 111, application server 109 leverages SOAP Web services client 132 that builds up an RRD Request object 140 including the serializable portions of the original request context. In process step 414, RRD Request object 140 is sent in a SOAP Message to remote resource footer.jsp 300 through network 128.

Continuing to process flow 400B, in process step 422, a SOAP Web services servlet 134 receives RRD Request object 140. In process step 424, RRD Request object 140 is deserialized to extract the information contained within the object, and an include operation of internal Controller servlet 136 is performed in Web container 120. The include operation of internal Controller servlet 136 allows remote application server 118 to control the request and response processing. A request is generated on remote application server 118 to internal Controller servlet 136 to perform an include operation on remote resource footer.jsp 300.

At process step 426, filter 138 in Web container 120 intercepts the request to Controller servlet 136 and wraps the request and response information with the information deserialized from the SOAP Message which carried RRD Request object 140, making the request appear as if its coming from the original Web component 114. This allows the remote resource footer.jsp 300 to access the requestor's related state such as POST data from the original request, original request headers, security credentials, HttpServletRequest attributes, HttpSession identifiers, locale, character encoding, and request URL path elements.

At process step 428, Controller servlet 136 includes the content of target resource Web component 124 in the response output. At process step 430, Web component 124's response output and state are serialized as RRD Response object 142. At process step 432, RRD Response object 142 is sent through SOAP Web service 134 back to local application server 109 in a SOAP message.

Returning to process flow 400A, at process step 418, local application server 109 deserializes RRD Response object 142, extracting data and state information. State information in RRD Response object 142 from remote application server 118 may include state change indicators such as whether a writer or output stream was obtained. At process step 420, the requested remote resource footer.jsp 300 contents are included in the response to client system 104 as part of the response from local resource include.jsp 200; this occurs after process step 416 or 418 obtains requested remote resource footer.jsp 300 output using either the prior art methods or the new inventive method of a remote request dispatcher.

Since an RRD supports transparent calling of remote resources across application servers while including the requesting resource's related state, this enables applications and Web components to function as if they are running within a common environment. Thus interdependent applications may be moved from a common application server and installed on separate application servers without requiring modification of the application code.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for dispatching requests to a remote resource using a remote request dispatcher (RRD) in a managed multiple application server environment comprised of a local application server and a remote application server, said method comprising:
executing a local resource on a local Web module on the local application server, said local resource containing a reference to a remote resource on a remote Web module on the remote application server;
locating the remote Web module associated with the referenced remote resource;
building an RRD request object on the local application server;
sending the RRD request object from the local application server to the remote application server;
receiving the RRD request object on the remote application server;
including an internal controller servlet in the remote application server;
generating a request on the remote application server to the internal controller servlet to perform an include operation on the remote resource;
intercepting the request to the internal controller servlet on the remote application server;
wrapping the request to the internal controller servlet with information received in the RRD request object on the remote application server;
building an RRD response object on the remote application server comprising:
remote resource contents;
remote resource response output; and
remote resource response state;
sending the RRD response object from the remote application server to the local application server;
receiving the RRD response object on the local application server; and
making contents of the RRD response object available to the local resource.

2. The method of claim 1, wherein locating the remote Web module associated the referenced remote resource is comprised of:
calling a Web container of the local Web module to determine the remote Web module associated with a context of the remote resource;
returning the context of the remote resource if the context is found by the local Web container; and
searching other application servers in the managed multiple application server environment for the remote application server holding the remote Web module associated with the referenced remote resource.

3. The method of claim 1, wherein sending the RRD request object from the local application server to the remote application server is further comprised of:
passing the RRD request object to a Web services client;
serializing the RRD request object; and
sending the RRD request object to the remote application server in a Simple Object Access Protocol (SOAP) message.

4. The method of claim 1, wherein sending the RRD response object from the remote application server to the local application server is further comprised of:
passing the RRD response object to a Web services client;
serializing the RRD response object; and
sending the RRD response object to the local application server in a Simple Object Access Protocol (SOAP) message.

5. The method of claim 1, wherein the local resource on the local Web module on the local application server receives a request to execute from a client system.

6. The method of claim 5, wherein the local resource outputs a response to the client system request, said response including output from both the local resource and the remote resource.

7. A system for dispatching requests to a remote resource using a remote request dispatcher (RRD) in a managed multiple application server environment, comprising:
a local application server, the local application server performing:
executing a local resource on a local Web module, said local resource containing a reference to a remote resource on a remote Web module on a remote application server;
locating the remote Web module associated with the referenced remote resource;
building an RRD request object;
sending the RRD request object to the remote application server;
receiving an RRD response object; and
making contents of the RRD response object available to the local resource; and
a remote application server, said the remote application server performing:
receiving the RRD request object;
including an internal controller servlet;
generating a request to the internal controller servlet to perform an include operation on the remote resource;
intercepting the request to the internal controller servlet;
wrapping the request to the internal controller servlet with information received in the RRD request object;
building the RRD response object comprising:
remote resource contents;
remote resource response output; and
remote resource response state; and
sending the RRD response object to the local application server.

8. The system of claim 7, wherein locating the remote Web module associated the referenced remote resource is comprised of:
calling a Web container of the local Web module to determine the remote Web module associated with a context of the remote resource;
returning the context of the remote resource if the context is found by the local Web container; and
searching other application servers in the managed multiple application server environment for the remote application server holding the remote Web module associated with the referenced remote resource.

9. The system of claim 7, wherein sending the RRD request object from the local application server to the remote application server is further comprised of:
passing the RRD request object to a Web services client;
serializing the RRD request object; and
sending the RRD request object to the remote application server in a Simple Object Access Protocol (SOAP) message.

10. The system of claim 7, wherein sending the RRD response object from the remote application server to the local application server is further comprised of:
passing the RRD response object to a Web services client;
serializing the RRD response object; and
sending the RRD response object to the local application server in a Simple Object Access Protocol (SOAP) message.

11. The system of claim 7, wherein the local resource on the local Web module on the local application server receives a request to execute from a client system.

12. The system of claim 11, wherein the local resource outputs a response to the client system request, said response including output from both the local resource and the remote resource.

13. A computer program product for dispatching requests to a remote resource using a remote request dispatcher (RRD) in a managed multiple application server environment comprised of a local application server and a remote application server, said computer program product comprising:
executing a local resource on a local Web module on the local application server, said local resource containing a reference to a remote resource on a remote Web module on the remote application server;
locating the remote Web module associated with the referenced remote resource;
building an RRD request object on the local application server;
sending the RRD request object from the local application server to the remote application server;
receiving the RRD request object on the remote application server;
including an internal controller servlet in the remote application server;
generating a request on the remote application server to the internal controller servlet to perform an include operation on the remote resource;
intercepting the request to the internal controller servlet on the remote application server;
wrapping the request to the internal controller servlet with information received in the RRD request object on the remote application server;
building an RRD response object on the remote application server comprising:
remote resource contents;
remote resource response output; and
remote resource response state;
sending the RRD response object from the remote application server to the local application server;
receiving the RRD response object on the local application server; and
making contents of the RRD response object available to the local resource.

14. The computer program product of claim 13, wherein locating the remote Web module associated the referenced remote resource is comprised of:
calling a Web container of the local Web module to determine the remote Web module associated with a context of the remote resource;
returning the context of the remote resource if the context is found by the local Web container; and
searching other application servers in the managed multiple application server environment for the remote application server holding the remote Web module associated with the referenced remote resource.

15. The computer program product of claim 13, wherein sending the RRD request object from the local application server to the remote application server is further comprised of:
passing the RRD request object to a Web services client;
serializing the RRD request object; and
sending the RRD request object to the remote application server in a Simple Object Access Protocol (SOAP) message.

16. The computer program product of claim 13, wherein sending the RRD response object from the remote application server to the local application server is further comprised of:
passing the RRD response object to a Web services client;
serializing the RRD response object; and
sending the RRD response object to the local application server in a Simple Object Access Protocol (SOAP) message.

17. The computer program product of claim 13, wherein the local resource on the local Web module on the local application server receives a request to execute from a client system.

18. The computer program product of claim 17, wherein the local resource outputs a response to the client system request, said response including output from both the local resource and the remote resource.
